(19) United States
(12) Patent Application Publication
(10) Pub. No.: US 2007/0228993 A1
(43) Pub. Date: Oct. 4, 2007

(54) High-Pressure Sodium Lamp

(75) Inventors: Cindy Blondine Andre Stuer, Turnhout (BE); Jerzy Janczak, Eindhoven (NL); Hannelore Marie Lea Elise Herremans, Turnhout (BE); Josephus Christiaan Maria Hendricx, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,617

(22) PCT Filed: Apr. 5, 2005
(86) PCT No.: PCT/IB05/51117

§ 371 Date: Oct. 3, 2006

(30) Foreign Application Priority Data
Apr. 9, 2004 (EP) 04101475.4

(51) Int. Cl. H01J 61/12; H05B 41/24

(52) U.S. Cl. 315/246; 313/567; 313/570; 313/573

(57) ABSTRACT

The invention is related to high pressure sodium lamp having a nominal power Pla. The lamp, which is designed to be operated at a very high frequency (VHF), has a discharge tube with a ceramic wall and an internal vessel diameter Dᵢₙₜ, which encloses a discharge space in which a pair of electrodes at a mutual electrode distance ed and a filling of Na-amalgam with a sodium mol fraction (smf).

According to the invention the discharge tube has a ratio ed/Dᵢₙₜ of at most 7, preferably between about 5.5 and 4.0.

The invention relates to a high-pressure sodium (HPS) lamp with as high as possible luminous efficacy suitable to be operated at a very high frequency (VHF). When operated the lamp is driven by a full electronic driver also known as a full electronic ballast. The frequency is preferable taken above the region in which acoustic resonance might occur in the lamp.

The invention also relates to a lighting system comprising a full electronic VHF driver for operating a said high-pressure sodium (HPS) lamp.

Known HPS lamps are provided with a discharge vessel or discharge tube, having a ceramic wall. Ceramic means in this context a wall made of crystalline metal oxide, like mono crystalline sapphire or densely sintered poly crystalline metal oxide, for instance poly crystalline alumina (PCA) and YAG, or metal nitride like AlN. These materials are well known in the art for their ability to be prepared with good translucent properties.

In this description and these claims discharge vessel, discharge tube and burner are equivalent of each other.

The power for which the lamp is designed to be operated in steady state without dimming is called the nominal lamp power (Pla) or nominal power rating of the lamp.

Standard HPS lamps are intended amongst others for general lighting like public lighting and thus designed with as high as possible luminous efficacy. A consequence of this is that these lamps have rather poor color properties. Especially the general color rendering index Ra has a very low value for these lamps, is in general not more than about 20. The lamps are designed for operation on conventional ballasts, mostly having an inductive element as current stabilization. On such ballasts the standard HPS lamps, known as SON Plus 50, 70, 100 and 150 W lamps have efficacies of 83, 90, 105 and 117 lm/W respectively. The lamp voltage (Vla) of these lamps is in the range of about 90 to 100V. To arrive at an acceptable compromise between lamp efficacy and field strength an amalgam composition with a sodium mole fraction (smf) between 0.663 and 0.739 is chosen. The resulting electrode distances are 37, 39, 45, and 59 mm for SON Plus 50, 70, 100 and 150 W lamps respectively. The required lamp voltage of about 100 V (at 220 to 240V mains) for the presently known lamps has a disadvantageous consequence for lamp length and thus system luminous efficacy, because long lamps show a lower optical efficacy in general lighting applications, like for instance street lighting, than shorter lamps. Lamps designed for relatively low supply sources of 110 to 130V have a lamp voltage of about 50V. Drawback of these lamps is the relative large losses due to high current values resulting in a generally lower luminous efficacy of the lamp. A further drawback is formed by the restricted applicability on low voltage supply sources only.

During lamp life of a known lamp the lamp voltage increases and with operation on a conventional ballast also the lamp power increases, which results in an increase of the wall temperature of the discharge tube of the lamp. Besides, also the mains voltage can vary, which can result in a higher lamp power and a consequently increase of the wall temperature. To arrive at acceptable life times the SON Plus lamps are designed to be able to withstand these higher wall temperatures to a large extend. Therefore the lamp is designed such that the initial (100 h) wall temperature during operation at nominal power will be relatively low (below 1500 K). In this respect the thickness of the PCA wall is necessarily chosen relatively high (0.6-1.1 mm). A relative thick wall requires a relatively small tube diameter to compensate thermal losses and arrive at desired values (>1400 K) for the wall temperature. Too low values of the wall temperature result in loss of lamp efficacy and consequently in unacceptable low values for the luminous efficacies of said lamps.

Besides limiting the wall temperature a relative thick wall will also reduce thermal stress and thus counteracts the danger of cracking of the PCA wall during run up and cooling down of the lamp.

The pressure of the starting gas which is used for reliable igniting the lamp is relatively low. In SON-Plus lamps Xe is used as starting gas with cold pressures below 300 mbar (at room temperature). To further facilitate ignition the discharge tubes are commonly provided with an antenna. The Xe pressure (p_{Xe}) is low in order to guarantee an ignition voltage below 2800 V (determined by IEC norm) at the relatively large electrode distances.

During a certain period in the run up phase of the lamp on a conventional ballast the lamp current is about twice as high as in stationary operating conditions. Electrodes need to be designed for this high initial current. They are thus relatively heavy for the considerably lower currents during nominal operation, which is harmful for the lamp efficacy.

Standard SON Plus lamps are operated on conventional ballasts with relatively high ballast losses and with variations in lamp power during life-time. These form drawbacks of the known lamps. Today's luminaries however are optimized for these lamp and ballast combinations.

However, new full electronic very high frequency (VHF) drivers fulfilling the ballast function offer a number of new system opportunities in miniaturization, design and energy saving, which also result in cost savings. These new opportunities are however not achievable with the presently known lamps neither when operated on conventional inductive ballasts, nor in combination with operation on a full electronic VHF ballast, which is considered as drawbacks of the known systems.

It is an object of the invention to provide a lamp which is suitable to be operated at a very high frequency (VHF) and thus exploit the opportunities of full electronic VHF ballasts.

In a first embodiment the objective is met by a high pressure sodium lamp having a nominal power Pla, which is suitable to be operated at a very high frequency (VHF), having a discharge tube with a ceramic wall and an internal vessel diameter Dᵢₙₜ, enclosing a discharge space in which a pair of electrodes at a mutual electrode distance ed and a filling of Na-amalgam with a sodium mol fraction (smf), wherein the discharge tube has a ratio ed/Dᵢₙₜ between about 5.5 and 4.0.

An important advantage of the lamp according to the object of the invention is the freedom in choice of lamp voltage and thus of electrode distance.

In a further embodiment of the lamp according to the object of the invention the wall thickness (wt) of the wall of the ceramic discharge tube is chosen as small as possible for all lamp types: 0.4≦wt≦0.6 mm, so as to keep the wall temperature high enough (≧1400K) in combination with large tube diameters for optimal luminous efficacy.

In a further embodiment of the lamp according to the object of the invention the lamp has a wall load of at most 30 W/cm².

In yet a further embodiment of the lamp according to the object of the invention the filling has an amalgam composition for which holds 0.6<smf<0.75. This has turned out to be an optimal compromise between maximum efficacy and field strength optimization.

In yet a further embodiment of the lamp according to the object of the invention a large internal tube diameter (Dᵢₙₜ) (for instance 5-7.5 mm for a HPS lamp of nominal power rating in the range of 90-140 W and 3-5 mm for a HPS lamp in the range of 40-65 W) is chosen in relation to the nominal lamp power Pla which satisfies the relation: 0.045≦Dᵢₙₜ/Pla≦0.08. Herewith the lamp luminous efficacy is optimized.

In yet a further embodiment of the lamp according to the object of the invention a short electrode distances (ed) (roughly about half of the ed for the known lamp of the same nominal power rating) is chosen in relation to the nominal lamp power Pla which satisfies the relation: 0.2≦ed/Pla≦0.35. For a wide range of lamp power ratings, in particular in the range of about 40 to 140 W lamps this results in a value of the lamp voltage Vla in the range of about 40V to about 65V.

In yet another embodiment of the lamp according to the object of the invention the filling also comprises Xe having a pressure at room temperature in the range 400 mbar≦P_{Xe}≦1000 mbar. With the p_{Xe} in the said range it turns out that lamp efficacy and maintenance are improved, while at the same time sufficient low breakthrough voltages can be maintained.

In yet another embodiment of the lamp according to the object of the invention the electrodes are provided with emitter and each of the electrodes has a small electrode rod diameter with respect to the applied nominal and run-up current which minimizes electrode losses and avoids sputtering or melting of the emitter and/or the electrode. The electrode diameter can be specified relatively to the average lamp current (Iₗₐ) at nominal lamp power by: 0.2<(D_{electrode})²/Iₗₐ<0.45 (wider range), preferably 0.25<(D_{electrode})²/Iₗₐ<0.35 (narrow range).

Opportunities possible with operating the invented lamp on full electronic VHF ballast and the related advantages are elucidated in more detail hereafter.

Control of lamp power Pla and thus of the wall temperature Twall. A full electronic driver providing the ballast function provides the possibility to overcome power variations (and thus wall temperature variation) due to mains voltage variations and/or due to Na loss during lamp life by means of lamp power control, preferably by power stabilization. The forced use of relatively thick walls (0.6-1.1 mm) combined with relatively small tube diameters is herewith expired. New optimal choices are possible for these lamp parameters in optimizing the lamp and/or system efficacy. Higher lamp efficacies (luminous efficacy of the lamp) with thinner walls and larger tube diameters are possible. This can be translated in lower lamp power if lamp fluxes should be kept the same.

Control of the current and/or power during run-up. If the maximum run-up current is kept about equal to the nominal lamp current (in steady state operation) the power dissipated during run up is significantly lower than in the case of the known lamp operated on a conventional ballast, for which the lamp current during ignition and run-up can be as high as twice the lamp current during steady state operation. Thick walls to minimize temperature gradients as function of time to avoid cracks during run-up are not necessary anymore.

Shorter electrode distances, in the case of operation on full electronic VHF driver, make higher Xe pressures possible. Also resonant ignition, easy realizable in VHF drivers, leads to a reduced level of ignition voltage and thus to the possibility to use a higher fill pressure of Xe. In the invented lamp an antenna is no longer indispensable for reliable ignition of the lamp. Without antenna a slightly higher lamp efficacy is achievable. Furthermore increase of the Xe pressures has a positive influence on several lamp characteristics: voltage, efficacy and maintenance.

With full electronic VHF ballast the run-up current can be controlled. By keeping the maximum run-up current about equal to or below the nominal current, electrodes can be optimized for nominal operation, which means that the electrode diameter can be much smaller. However a shorter electrode distance resulting in a lower lamp voltage Vla and thus a higher current, does require a larger electrode diameter. The resulting electrode diameter in the invented lamp is thus in fact optimized for as well run-up as nominal operation, which means that the chance on sputtering or melting is lower, which results in a better maintenance of the electrode and consequently of the lamp.

The relatively high ballast losses of about 14 W in a 70 W conventional ballast and about 18 W in a 150 W ballast can be reduced significantly with the use of a full electronic VHF ballast. VHF ballasts for the 65 W and 140 W lamps according to the invention show losses of respectively 6 and 12 W only. This leads to a higher system efficacy.

The lamp according to the invention, which is a miniaturized lamp is advantageously applied in a miniaturized luminary. The lamp is designed in such a way that a compromise is found between optimal system luminous efficacy, miniaturization, and energy saving. The resulting systems are more attractive in general lighting, like street lighting applications than the existing ones.

The lamp is operated on a VHF ballast, preferably construed as single stage VHF ballast to minimize ballast losses. In addition preferably the VHF ballast is provided with resonant ignition means by which resonant ignition is applied on igniting the lamp and thus keep the maximum ignition voltage as low as 2 kV.

Aspects of the invention as described in the above mentioned embodiments and further aspects of the invention are further elucidated with reference to the Figures, in which:

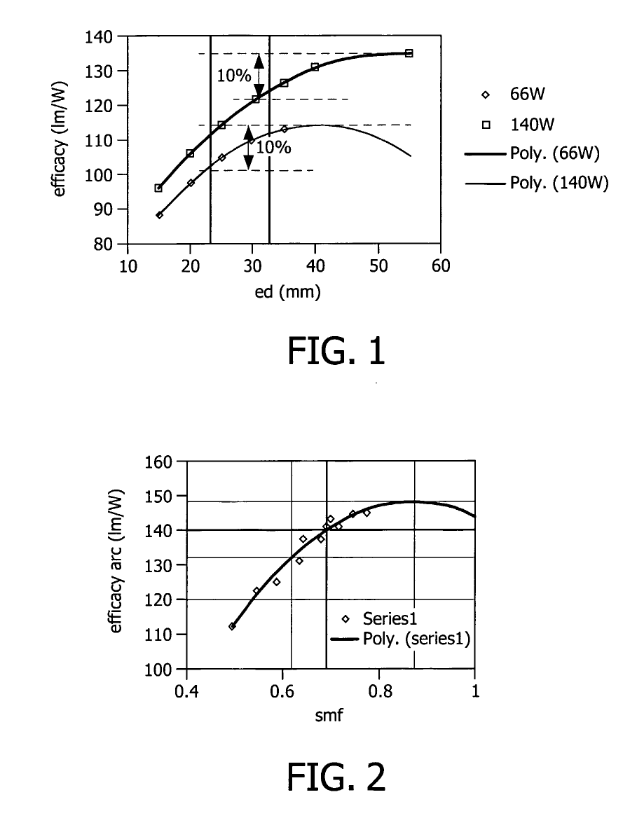

FIG. 1 shows some calculation results of lamp efficacies as function of electrode distance ed;

FIG. 2 shows the efficacy of the discharge arc (not lamp efficacy !) as function of the smf at a constant ed and at a Na pressure corresponding with delta lambda Na=10 nm;

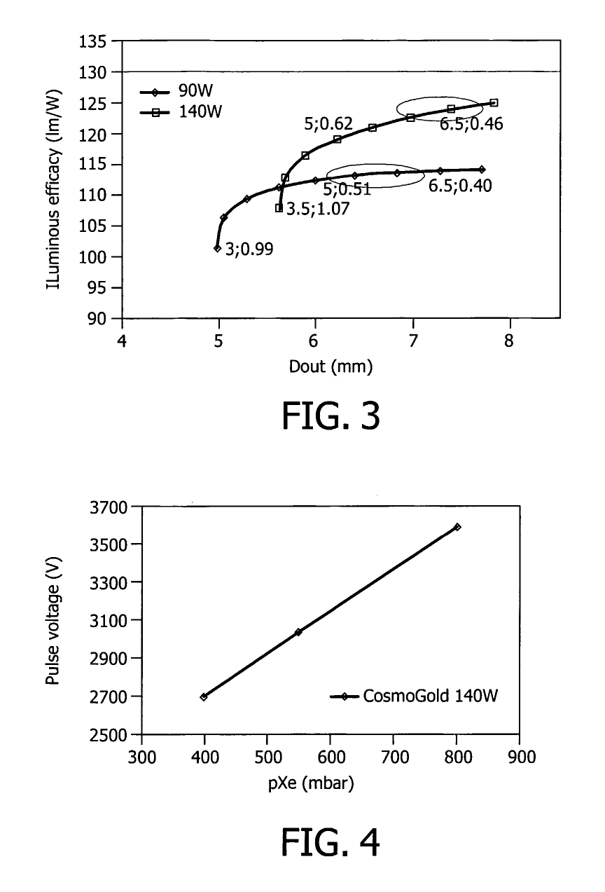

FIG. 3 shows the calculated lamp efficacies as function of the outer discharge tube diameter (dt);

FIG. 4 gives the pulse ignition voltage as function of the xenon pressure for the lamp according to the invention, and

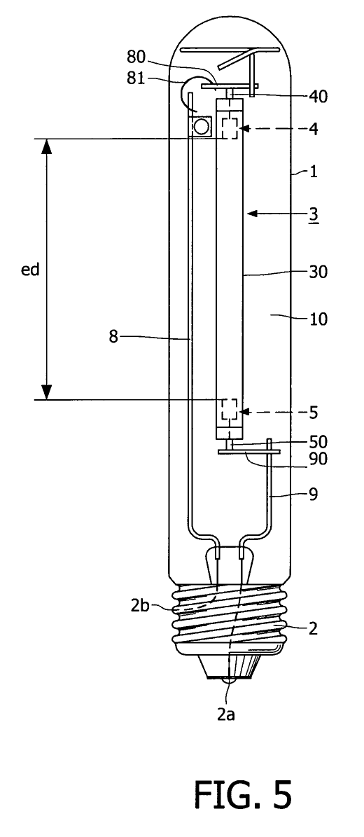

FIG. 5 shows a lamp embodiment according to the invention.

On an electronic ballast it is possible to freely choose the lamp voltage, in contrast to case wherein the lamp is operated on a conventional CuFe ballast. A shorter light source (shorter electrode distance) gives the possibility to bundle the light emitted from the luminary more effectively with as consequence a higher flux on the surface to be illuminated.

A consequences of a shorter electrode distance is a lower lamp voltage and thus a higher lamp current. A higher lamp current leads to a higher power loss in the ballast, which on its turn leads to a decrease in efficacy of the lamp (especially if Hg rich amalgam is used to limit the voltage drop). The optimal system efficacy thus is a compromise between lamp, ballast and luminary efficacy.

A lower electrode distance and thus a higher lamp current in combination with a high ballast efficiency (>90%) is thus only be possible if a VHF ballast is used. In a VHF ballast the losses are significantly lower than in conventional ballasts: 6 and 12 W for respectively a 66 and 140 W lamp according to the invention with Vla=55V compared to 14 and 18 W for respectively known 70 and 150 W SON Plus lamps with Vla=100V.

Experiments with luminary designs show that significant shorter ed's (50% shorter) lead to an increased flux on the illuminated surface of at least 5% The lamp efficacy losses due to shorter ed's should thus stay at least within this range, but preferably the lamp flux should be equal or even slightly higher to come to energy savings at equal lamp flux.

FIG. 1 shows some calculation results of lamp efficacies as function of ed for a 66 W and 140 W lamp. If 10% efficacy loss of the lamp is accepted, with respect to an ideal design of the known lamp, ed should have a minimum value of about 22 mm at a calculated wall thickness of 0.56 mm for the 66 W lamp and for the 140 W lamp a minimum value of about 32 mm at a calculated wall thickness of 0.5 mm.

The calculated efficacies of such 66 W and 140 W burners according to the invention are respectively 100 and 124 lm/W, which correspond very good with measured values of practical embodiments.

Compared to the efficacies realized with known 70 W and 150 W SON Plus lamps (90 and 117 lm/W respectively) this is clearly higher, in spite of the shorter ed.

For such a 66 W and 140 W lamp according to the invention ed/Pla is:

22/65=0.34 (66 W)

32/140=0.23 (140 W).

For a comparable known SON Plus 70 W and 150 W lamp ed/Pla is:

40/73=0.54 (70 W)

64/154=0.41 (150 W), which are significant higher values.

For these calculations, a 800 mbar Xe pressure is used for all electrode distances resulting in comparable efficacies at strongly reduced electrode distances. However, in the practical embodiments the required ignition voltage tends to decrease with decreasing electrode distance. Consequently at constant ignition voltage the allowable Xe fill pressure will be higher in the lamps according to the invention, resulting in a higher luminous efficacy, with a similar ignition behavior.

Optimal arc luminous efficacies can be achieved with a smf between 0.6 and 0.75. A lower smf leads to a higher lamp voltage, which would result in a lower current and thus a reduction in electric losses, however at the expense of a lower arc efficacy. Values of the smf above 0.75 will result in lower arc voltages combined with neglectable differences in arc efficacy, but with increased overall electric losses. In FIG. 2 the efficacy of the discharge arc (not lamp efficacy !) is shown as function of the smf at a constant ed and at a Na pressure corresponding with delta lambda Na=10 nm. Herein delta lamda is defined as the wavelength separation between the maximal of the self-reversed sodium D-lines in the spectrum of the light generated by the discharge tube. From FIG. 2 it can be deduced that if a drop in arc efficacy of more than 10% should be avoided smf should be larger than 0.6. Smf values between 0.6 and 0.75 are recommended as a compromise between arc efficacy and lamp voltage.

Large internal diameters lead to more efficient HPS lamps. If these diameters are combined with thin tube walls the lamp efficacy will increase even more. The minimum wall thickness is limited of course by the maximum allowable wall temperature. On full electronic ballasts, the lamp power is stabilized independent of Na loss and mains variations. Through the lamp power stabilization the wall temperature is controlled. This means that initially a higher wall temperature is allowable in comparison to the known lamp operated on a conventional ballast, resulting in a higher lamp efficacy. On the contrary thin walls at high Twall increase the risk of fast Na loss. Therefore it is advisable to keep the wall temperature below 1550K. These requirements lead to an optimal wall thickness of: 0.4 mm≦wt≦0.6 mm.

FIG. 3 shows the calculated lamp luminous efficacies as function of the outer discharge tube diameter (dt). The electrode distance ed is kept constant as well as the value for Twall. As a consequence the value for the wall thickness varies along each curve shown. The resulting values for wt and Dᵢₙₜ are shown in frames at several points along each curve. The graphs show that for a 140 W lamp with discharge tube with large outer diameter of 7.5 mm having a thin wall of 0.4 mm the efficacy is about 1251 m/W. A 90 W lamp according to the invention can achieve a luminous efficacy of about 114 μm/W at an outer dt diameter of 7.3 mm corresponding with an internal diameter Dᵢₙₜ of 6.5 mm.

The corresponding values for Dᵢₙₜ/Pla of lamps according to the invention are:

6.5/90=0.07 for a 100 W lamp

6.7/140=0.048 for a 140 W lamp.

For known SON Plus 70, 100 and 150 W lamps these values are respectively 3.8/73=0.052, 4.0/100=0.04 and 5.0/154=0.032 (a clear shift of this area).

Taking a 15% smaller Dᵢₙₜ at constant ed and keeping Twall constant result in the lamps according to the invention in a significant loss of luminous efficacy, which put a limit to further decrease of Dᵢₙₜ.

A wall thickness of 0.6 mm in the 140 W lamp, corresponds with a Dᵢₙₜ of about 5.2 mm. The calculated luminous efficacy has dropped to about 120 lm/W. In the 90 W lamp the calculated efficacy decreases to about 111 m/W when the wall thickness is increased to 0.6 mm corresponding with a Dᵢₙₜ of about 4.5 mm and a dt of about 5.7.

The measures described above result in the invented lamps in a ratio ed/Dᵢₙₜ between about 5.5 and 4.0. For the known SON Plus lamps this ratio is above 10 and increases with increasing nominal power to values above 12.

The wall load of the invented lamp is in the range of 15 to 25 W/cm², preferably in the range of 18 to 23 W/cm², however should not exceed 30 W/cm². Wall load is herein defined as the ratio between the nominal power rating of the lamp (nominal lamp wattage) and the internal tube surface over the electrode distance ed.

A higher p_{Xe} is advantageous for several lamp parameters: lamp efficiency, lamp maintenance and wall temperature. The most important restriction towards a higher xenon pressure is increase in the required ignition voltage.

For the lamp according to the invention the pulse ignition voltage is given as function of the xenon pressure in FIG. 4.

If a resonant ignitor is used, even lower ignition voltages are sufficient to guarantee a reliable ignition. A 2 kV ignition voltage is chosen for a 140 W lamp according to the invention with 550 mbar xenon pressure. The resonant ignition voltage is kept relatively low to keep the ballast price and dimensions low.

With a full electronic ballast the electrode dimensions can be minimized (minimal conduction losses). The run up current can be controlled (kept at about or below the same level as in steady state) and lamp power can be stabilized (no consequences of mains voltage variation and Na loss on the lamp voltage and power). So the electrode, optimized for nominal operation will not be overheated during run-up. The dimensions of the electrode can be defined relative to the current through the lamp during as well run-up as steady state operation. Because of the fact that heat conduction is related to the cross section of the electrode (Dₑₗ)²/Iₗₐ has been chosen as parameter to specify the limits for the electrode dimensions. For 66 and 140 W lamps according to the invention several electrode diameters have been tested. The best results are obtained with Dₑₗ is 0.6 and 0.9 mm for corresponding currents of respectively 1.2 and 2.55 A.

For the (Dₑₗ)²/Iₗₐ ratio this means:

0.36/1.2=0.3 (66 W)

0.81/2.55=0.32 (140 W)

Acceptable results have been achieved with ratio values between 0.2 and up to 0.45.

For comparable SON Plus 70 and 150 W lamps (Dₑₗ)₂/Iₗₐ is:

0.36/0.7=0.51 (70 W)

0.81/1.5=0.54 (150 W), clearly different.

The optimized lamp according to the invention preferably has a nominal power rating in the range from 40 to 140 W.

Several lamp embodiments have been made and tested. The most relevant data are shown in a table below.

| | Nominal lamp power Pla (W) | | |
|---|---|---|---|
| | 66 W | 140 W | 90 W |
| PCA dimensions | | | |
| Internal diameter (mm) | 4.50 | 6.31 | 5.2 |
| Dᵢₙₜ/Pla (mm/W) | 0.068 | 0.045 | 0.58 |
| Wall thickness (mm) | 0.54 | 0.51 | 0.51 |
| Filling | | | |
| amalgam composition | 15 mg Na/Hg | 20 mg Na/Hg | 20 mg Na/Hg |
| | (smf = 0.630) | (smf = 0.684) | (smf = 0.680) |
| Xe pressure (room | 568 | 442 | 442 |
| temperature) (mbar) | | | |
| Electrode | | | |
| Electrode distance (ed) | 22.6 | 32 | 27.8 |
| (mm) | | | |
| Electrode rod diameter | 0.600 | 0.900 | 0.730 |
| (mm) | | | |
| Ed/Pla | 0.34 | 0.23 | 0.31 |
| Lamp operating data | | | |
| Lumen output (lm) | 6711 | 17439 | 9816 |
| Lamp Efficiency | 102 | 125 | 109 |
| (lm/W) | | | |
| Lamp voltage (V) | 53.4 | 53 | 52 |
| Lamp current (A) | 1.24 | 2.6 | 2 |
| Wall load (W/cm²) | 20.7 | 22.1 | 19.8 |
| Twall | 1450 | 1550 | 1500 |
| Color temperature | 1934 | 2014 | 2032 |
| T_{C} (K) | | | |
| Color rendering index | 30/12 | 31/14 | 28/— |
| Ra₈/Ra₁₄ | | | |

The light spectrum generated by each embodiment corresponds with values for delta lambda Na of about 10 nm.

A single stage VHF ballast is used with a high efficacy (90%). The frequency varies from 150 kHz for 140 W to 200 kHz for 65 W. The operation frequency is chosen above the acoustic resonance's. A 2 kV resonant igniter is used. Preferably use is made of the 3^{rd} harmonic frequency of the VHF lamp operating frequency during the ignition process.

Run up current is approximately equal to the nominal current or slightly larger. It allows the choice of relatively thin electrodes.

The lamp is provided with an outer bulb enclosing the discharge tube and provided with a lamp base having electrical connections for connecting to a power source. The enclosed space between the outer bulb and the discharge vessel is preferably vacuum. Fillings of this space with nitrogen or any other inert gas are known in the art. Though higher wall loadings of the discharge tube will be possible, experiments have shown that in the end there is always a loss in efficacy.

FIG. 5 shows an embodiment of the invented lamp. The Figure is not to scale. In the FIG. 1 denotes an outer bulb, which is provided with a lamp cap 2. The outer bulb encloses a discharge tube 3 having a ceramic wall 30 and enclosing a discharge space 10. In the discharge space a pair of electrodes 4, 5 are arranged at a mutual electrode distance ed. Electrode 4 is electrically connected to an electrical contact 2b of the lamp cap by means of a lead through element 40 and current conductors 80, 81 and 8. Electrode 5 is electrically connected with a contact point 2a of the lamp cap by means of a lead through element 50 and current conductors 90 and 9.

1. High pressure sodium lamp having a nominal power Pla, which is suitable to be operated at a very high frequency (VHF), having a discharge tube with a ceramic wall and an internal vessel diameter Dᵢₙₜ, enclosing a discharge space in which a pair of electrodes at a mutual electrode distance ed and a filling of Na-amalgam with a sodium mol fraction (smf), characterized in that the discharge tube has a ratio ed/Dᵢₙₜ between about 5.5 and 4.0.

2. Lamp according to claim 1, characterized in that the wall thickness (wt) is 0.4≦wt≦0.6 mm.

3. Lamp according to claim 1, characterized in that the lamp has a wall load of at most 30 W/cm².

4. Lamp according to claim 1, characterized in that:
0.2≦ed/Pla≦0.35;
an amalgam composition with 0.6<smf<0.75;
the ratio internal discharge vessel diameter Dᵢₙₜ to the nominal lamp power Pla is 0.045≦Dᵢₙₜ/Pla≦0.08;
the wall thickness (wt) is 0.4≦wt≦0.6 mm.

5. Lamp according to claim 1, characterized in that the filling also comprises Xe having a pressure at room temperature in the range of 400 mbar≦pXe≦1000 mbar.

6. Lamp according to claim 1, characterized in that the electrodes are provided with emitter and that each of the electrodes has an electrode diameter, which specified relatively to the average lamp current (Ila) at nominal lamp power fulfils the relation: 0.2<(D_{electrode})²/Ila<0.45, preferably 0.25<(D_{electrode})²/Ila<0.35.

7. Lamp according to claim 1, characterized in that the lamp emits light in nominal operating condition with a color temperature T_{C} of at most 2500K.

8. A lighting system comprising a full electronic VHF driver for operating a lamp according to claim 1.

9. A system according to claim 8, wherein the VHF ballast is provided with resonant ignition means by which resonant ignition is applied on igniting the lamp.
